(19) United States
(12) Patent Application Publication
(10) Pub. No.: US 2022/0147835 A1
(43) Pub. Date: May 12, 2022

(54) KNOWLEDGE GRAPH CONSTRUCTION SYSTEM AND KNOWLEDGE GRAPH CONSTRUCTION METHOD

(71) Applicant: Institute For Information Industry, Taipei (TW)

(72) Inventors: Hsin-Yi KUO, Taipei (TW); Wen-Nan WANG, Taipei (TW); Jia-Wei KAO, Taipei (TW); Wen-Fa HUANG, Taipei (TW); Po-Hsien CHIANG, Taipei (TW); Fu-Jheng JHENG, Taipei (TW); Yi-Hsiu LEE, Taipei (TW); Yu-Chuan YANG, Taipei (TW)

(21) Appl. No.: 17/111,499

(22) Filed: Dec. 3, 2020

(30) Foreign Application Priority Data
Nov. 9, 2020 (TW) 109139046

(51) Int. Cl. G06N 5/02; G06N 5/04; G06F 40/279; G06K 9/62; G06N 3/08

(52) U.S. Cl. CPC G06N 5/02; G06N 5/04; G06N 3/08; G06K 9/6256; G06F 40/279

(57) ABSTRACT

A knowledge graph construction system and method are disclosed. The system generates a recommended subject entity, at least one recommended object entity, and at least one recommended relation for a piece of text data according to the text data and a plurality of triples. The system displays the recommended object entity and the recommended relation at a current paragraph of the text data according to the recommended subject entity for user to select. The system receives a confirmed message related to the recommended subject entity, a recommended object entity selected by user from the at least one recommended object entity, and a recommended relation selected by user from the at least one recommended relation. The system adds the recommended subject entity and the selected recommended object entity and recommended relation to the triples, and constructs a current knowledge graph by using the triples according to the confirmed message.

### PRIORITY

This application claims priority to Taiwan Patent Application No. 109139046 filed on Nov. 9, 2020, which is incorporated herein by reference in its entirety.

### FIELD

The present disclosure relates to construction of knowledge graphs. More specifically, the present disclosure relates to a knowledge graph construction system and a knowledge graph construction method.

### BACKGROUND

Knowledge graph is a kind of data structure composed of a plurality of entities and relations. Through a knowledge graph, a semantic relation network corresponding to unstructured data (for example, text data) may be exhibited. “Entity” and “relation” are equivalent to “node/point” and “edge” in the structure of the knowledge graph. Two “entities” and one “relation” can form a “triple”, and in a “triple”, “relation” represents the relation between the two “entities”.

In order to construct a corresponding knowledge graph for a specific field, it is usually necessary to manually construct a plurality of triples for multiple pieces of text data in the specific field, and then integrate these triples to construct a corresponding knowledge graph. However, the construction of knowledge graph requires manually annotating triples for a large amount of text data, same triples also need to be annotated repeatedly, and the process of annotating the text data often relies on professional knowledge and experience and also consumes a lot of time, which leads to the inefficiency of the existing knowledge graph construction technology when constructing the knowledge graph.

Accordingly, an urgent need exists in the art to increase the efficiency of knowledge graph construction.

### SUMMARY

To solve at least the aforesaid problems, certain embodiments of the present invention provide a knowledge graph construction system. The knowledge graph construction system may comprise an operation interface, a storage and a processor that are electrically connected with each other. The operation interface may be configured to input and display a piece of text data. The storage may comprise a database which may be configured to store a plurality of triples, wherein each of the plurality of triples comprises a subject entity, an object entity, and a relation between the subject entity and the object entity. The processor may be configured to: generate a recommended subject entity of the text data according to the text data and the plurality of triples in the database; display, through the operation interface, at least one recommended object entity corresponding to the recommended subject entity, and at least one recommended relation between the recommended subject entity and each of the at least one recommended object entity at a current paragraph of the text data according to the recommended subject entity for a user to select; receive, through the operation interface, a confirmed message, wherein the confirmed message is related to the recommended subject entity, a recommended object entity selected by the user from the at least one recommended object entity, and a recommended relation selected by the user from the at least one recommended relation; store the recommended subject entity, the recommended object entity which is selected, and the recommended relation which is selected in the database according to the confirmed message, so as to add the recommended subject entity, the recommended object entity which is selected, and the recommended relation which is selected to the plurality of triples; and construct a current knowledge graph by using the plurality of triples.

To solve at least the aforesaid problems, certain embodiments of the present invention further provide a knowledge graph construction method. The knowledge graph construction method may comprise the following steps: inputting and displaying, by a knowledge graph construction system, a piece of text data; generating, by a knowledge graph construction system, a recommended subject entity of the text data according to the text data and a plurality of triples in a database, wherein the plurality of triples are stored in the knowledge graph construction system, and each of the plurality of triples comprises a subject entity, an object entity, and a relation between the subject entity and the object entity; displaying, by the knowledge graph construction system, at least one recommended object entity corresponding to the recommended subject entity, and at least one recommended relation between the recommended subject entity and each of the at least one recommended object entity at a current paragraph of the text data according to the recommended subject entity for a user to select; receiving, by the knowledge graph construction system, a confirmed message, wherein the confirmed message is related to the recommended subject entity, a recommended object entity selected by the user from the at least one recommended object entity, and a recommended relation selected by the user from the at least one recommended relation; storing, by the knowledge graph construction system, the recommended subject entity, the recommended object entity which is selected, and the recommended relation which is selected in the database according to the confirmed message, so as to add the recommended subject entity, the recommended object entity which is selected, and the recommended relation which is selected to the plurality of triples; and constructing, by the knowledge graph construction system, a current knowledge graph by using the plurality of triples.

When analyzing the text data, the knowledge graph construction system and the knowledge graph construction method in certain embodiments consider the pre-stored triples in the database to generate recommended annotations (i.e., the recommended subject entity, the recommended object entity, and the recommended relation). By directly comparing the pre-stored triples with the current paragraph in the text data, the present invention can directly find out the same or similar recommended annotations as the pre-stored triples from the current paragraph, which actually increases the efficiency of annotating the text data and further increases the efficiency of knowledge graph construction. Accordingly, the knowledge graph construction system and the knowledge graph construction method provided by the present invention indeed solve the above problems in the art.

What described above are not intended to limit the present invention, but only generally describe the technical problems that can be solved by the present invention, the technical means that can be adopted by the present invention, and the technical effects that can be achieved by the present invention so that a person having ordinary skill in the art can preliminarily understand the present invention. The detailed technology and preferred embodiments implemented for the subject invention are described in the following paragraphs accompanying the appended drawings for a person having ordinary skill in the art to well appreciate the features of the claimed invention.

### BRIEF DESCRIPTION OF THE DRAWINGS

The attached drawings are provided for describing various embodiments of the present invention, in which:

FIG. 1 illustrates a schematic view of a knowledge graph construction system according to some embodiments of the present invention;

FIG. 2A is a schematic view illustrating the operation of the knowledge graph construction system of FIG. 1 according to some embodiments of the present invention;

FIG. 2B to FIG. 2E are schematic views illustrating details of three kinds of operations of an operation 21 in FIG. 2A according to some embodiments of the present invention;

FIG. 3 illustrates a schematic view of displaying a piece of text data and an annotation information list on an operation interface according to some embodiments of the present invention; and

FIG. 4 illustrates a knowledge graph construction method according to some embodiments of the present invention.

### DETAILED DESCRIPTION

In the following description, a knowledge graph construction system and a knowledge graph construction method will be explained with reference to example embodiments thereof. However, these example embodiments are not intended to limit the present invention to any specific environment, applications or implementations described in these example embodiments. Therefore, description of these example embodiments is only for purpose of illustration instead of limiting the scope of the present invention. It shall be appreciated that, in the following embodiments and the attached drawings, elements unrelated to the present invention are omitted from depiction; and dimensions of elements and dimensional proportions among individual elements in the attached drawings are provided only for illustration, but not to limit the scope of the present invention. Unless stated particularly, same (or similar) reference numerals may correspond to same (or similar) elements in the following description. In the case of being applicable, the number of each element described below may be one or more unless otherwise specified.

Terms used in the present disclosure are only configured to describe embodiments, and are not intended to limit the present invention. Unless the context clearly indicates otherwise, singular forms “a” and “an” are intended to comprise the plural forms as well. Terms such as “comprising” and “including” indicate the presence of stated features, integers, steps, operations, elements and/or components, but do not exclude the presence of one or more other features, integers, steps, operations, elements, components and/or combinations thereof. The term “and/or” comprises any and all combinations of one or more associated listed items.

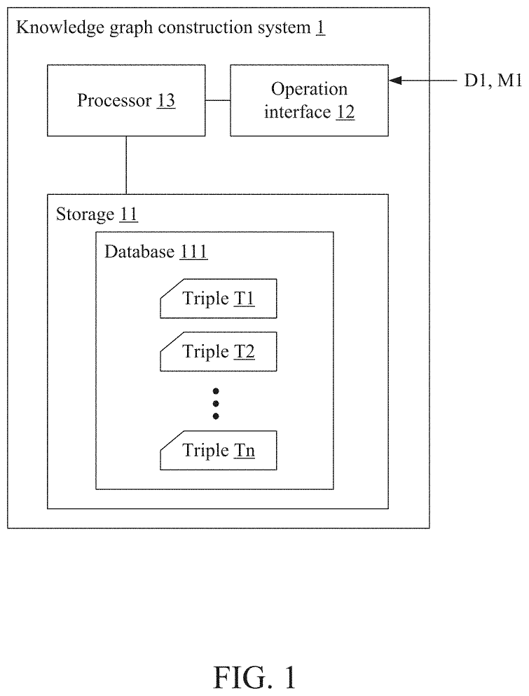

FIG. 1 illustrates a schematic view of a knowledge graph construction system according to some embodiments of the present invention. The content shown in FIG. 1 is for illustrating the embodiment of the present invention instead of limiting the scope of the present invention.

Referring to FIG. 1, a knowledge graph construction system 1 may basically comprise a storage 11, an operation interface 12 and a processor 13 which are electrically connected with each other. The electrical connection among the storage 11, the operation interface 12 and the processor 13 may be direct (i.e., connected with each other not via other functional elements), or indirect (i.e., connected with each other via other functional elements).

The knowledge graph construction system 1 may be one of various computing devices, such as but not limited to, desktop computers, portable computers, smart phones, portable electronic accessories (glasses, watches, etc.), and cloud servers.

The storage 11 may comprise various storage units included in general computing devices/computers, thereby realizing various corresponding functions as described below. For example, the storage 11 may comprise a primary memory (also referred to as main memory or internal memory), and the processor 13 may directly read instruction sets stored in the primary memory, and execute these instruction sets if needed. The storage 11 may also comprise a secondary memory (also referred to as external memory or auxiliary memory), and the memory at this level may use a data buffer to transmit data stored to the primary memory. The secondary memory may for example be a hard disk, an optical disk or the like, without being limited thereto. The storage 11 may also comprise a third-level memory, i.e., a storage apparatus that can be inserted into or pulled out from a computer directly, e.g., a mobile hard disk, or a cloud hard disk. The storage may comprise a database 111, and the database 111 may be configured to store a plurality of triples T1, T2, . . . , Tn. The number of triples shown in FIG. 1 is only illustrative instead of limitation.

The operation interface 12 may comprise various input/output elements included in general computer devices/computers for receiving data from the outside and outputting data to the outside, thereby realizing various functions as described below. The operation interface 12 may comprise, for example but not limited to, a mouse, a trackball, a touch pad, a keyboard, a scanner, a microphone, a user interface, a screen, a touch screen, a projector. In some embodiments, the operation interface 12 may comprise a human-machine interface (e.g., a graphic user interface) to facilitate interaction between the user and the knowledge graph construction system 1. The operation interface 12 may be configured to receive various data, such as but not limited to, a piece of text data D1 and a confirmed message M1. The operation interface 12 may also be configured to display various information, such as but not limited to, the text data D1, a recommended subject entity, at least one recommended object entity corresponding to the recommended subject entity, at least one recommended relation between the recommended subject entity and each of the at least one recommended object entity, and an annotation information list for the user to perform various operations.

The processor 13 may comprise various microprocessors or microcontrollers capable of signal processing or the like. A microprocessor or a microcontroller is a programmable specific integrated circuit that is capable of operating, storing, outputting/inputting or the like. Moreover, the microprocessor or the microcontroller may receive and process various coded instructions, thereby performing various logical operations and arithmetical operations and outputting corresponding operation results. The processor 13 may be programmed to interpret various instructions and execute various tasks or programs, thereby achieving various corresponding functions as described below.

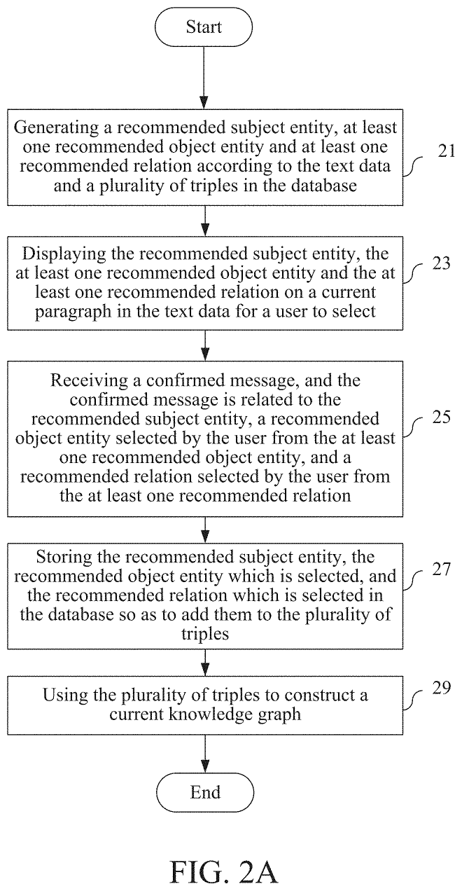

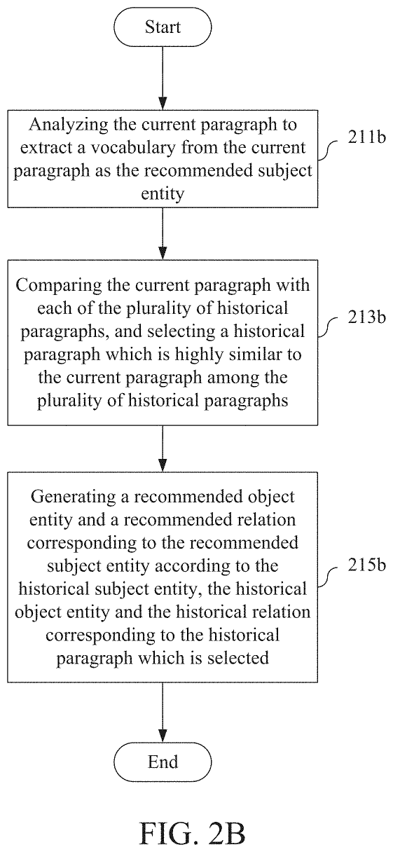

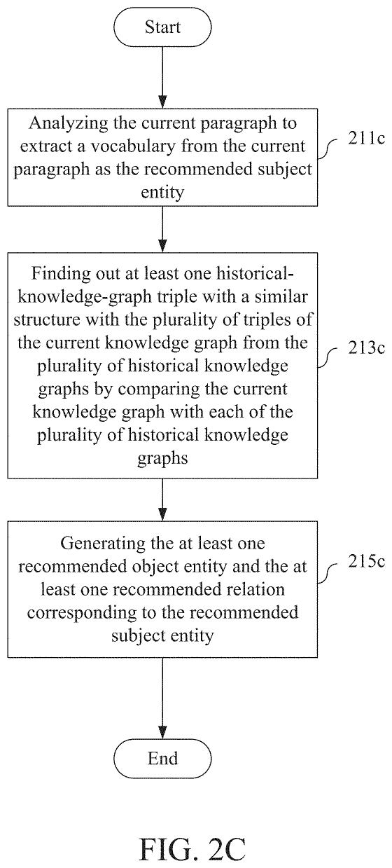

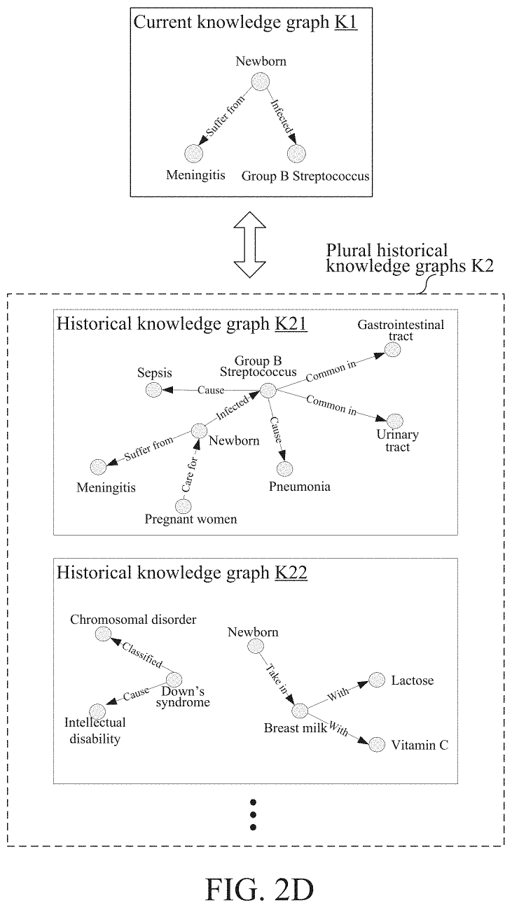

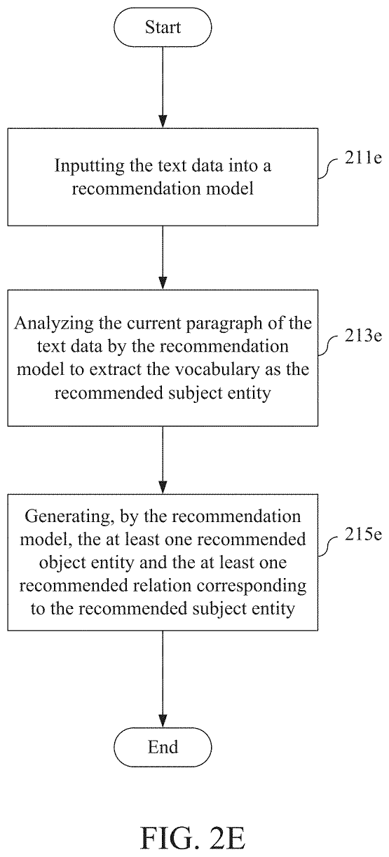

Next, the detailed operation of the knowledge graph construction system 1 according to some embodiments of the present invention will be explained with reference to FIG. 2A to FIG. 4. FIG. 2A is a schematic view illustrating the knowledge graph construction system of FIG. 1 constructing a knowledge graph according to some embodiments of the present invention. The content shown in FIG. 2A is for illustrating the embodiment of the present invention instead of limiting the scope of the present invention.

Referring to FIG. 2A, the knowledge graph construction system may construct knowledge graph by operations 21, 23, 25, 27 and 29, which will be described in detail as follows.

First, in the operation 21, the processor 13 may generate a recommended subject entity, at least one recommended object entity and at least one recommended relation of the text data Dl according to the text data Dl and a plurality of triples T1, T2, . . . , Tn in the database 111 (labeled as operation 21). In some other embodiments, it is possible that the processor 13 only generates the recommended subject entity, and the at least one recommended object entity and the at least one recommended relation may be generated by an external device and provided to the knowledge graph construction system 1.

The text data D1 may be various literal data or unstructured data (such as articles and press releases), and be input through the operation interface 12. For example, the user may directly input characters on the graphic interface provided by the operation interface 12 as the text data D1, or the user may transmit the text data Dl to the knowledge graph construction system 1 through various external devices.

Each of the triples Tl, T2, . . . , Tn is composed of a “subject entity”, a “object entity” and a “relation”, which may be expressed as “subject entity-relation-object entity” or “object entity-relation-subject entity”. Each of the “subject entity” and the “object entity” corresponds to a vocabulary, while the “relation” represents the relation between the two vocabularies which may be nouns, numbers, dates, or the like. In some embodiments, the “subject entity” comprised in the triple with directionality may be one of a “head entity” and a “tail entity”, and the “object entity” is the other one of the “head entity” and the “tail entity”.

In some embodiments, each of the “subject entity” and the “object entity” may correspond to an ontology class to represent meanings or generic concepts of the vocabularies thereof. For example, the vocabulary “gastrointestinal tract” may correspond to the ontology class of “organ”, the vocabulary “Down's syndrome” may correspond to the ontology class of “disease”, and the vocabulary “Group B Streptococcus” may correspond to the ontology class of “virus”, without being limited thereto.

Next, details of three kinds of operation of the operation 21 in different embodiments will be explained individually through FIG. 2B, FIG. 2C and FIG. 2D, and FIG. 2E. The contents shown in FIG. 2B to FIG. 2E are for illustrating the embodiments of the present invention instead of limiting the scope of the present invention.

First, please refer to FIG. 2B, in the embodiment shown in FIG. 2B, the processor 13 may complete operation 21 by performing actions 211b, 213b and 215b, and these actions will be described in detail as follows.

In the action 211b, the processor 13 may analyze the current paragraph to extract a vocabulary from the current paragraph as the recommended subject entity. Specifically, the processor 13 may extract a vocabulary from a current paragraph as the recommended subject entity by analyzing the current paragraph where the recommended subject entity is (i.e., the action 211b). In some embodiments, the processor 13 may analyze each paragraph in the text data D1 through semantic analysis or natural language processing, thereby performing process such as word segmentation and part of speech tagging for each paragraph, so as to determine a vocabulary that may be used as the recommended subject entity from each paragraph. In some other embodiments, the processor 13 may also take the vocabulary that has been annotated as an entity in the text data D1 as the recommended subject entity. In some other embodiments, the processor 13 may also take the vocabulary that has appeared in the historical paragraph in the text data D1 as the recommended subject entity. Each of the current paragraph, paragraph, historical paragraph or the like described above may contain more than one sentence.

In the action 213b, the processor 13 may compare the current paragraph with each of the plurality of historical paragraphs, and select a historical paragraph which is highly similar to the current paragraph among the plurality of historical paragraphs. The plurality of historical paragraphs, as well as the corresponding historical subject entity, the corresponding historical object entity, and the corresponding historical relation of each historical paragraph may be pre-stored in the database 111.

In detail, if one of the historical subject entity and the historical object entity corresponding to a historical paragraph is the same as the recommended subject entity (e.g., being the same vocabulary as the recommended subject entity) or similar to the recommended subject entity (e.g., belonging to the same ontology class as the recommended subject entity), and the other of the historical subject entity and the historical object entity indeed appears in the current paragraph, then the processor 13 may determine that the historical paragraph is highly similar to the current paragraph. For example, it is assumed that the recommended subject entity is “Group B Streptococcus”, and the current paragraph of the recommended subject entity is “If pregnant women carry Group B Streptococcus”. A certain historical paragraph is “Group B Streptococcus screening for pregnant women”, and the historical subject entity, the historical relation and the historical object entity corresponding to the historical paragraph are “pregnant women”, “containing” and “Group B Streptococcus” respectively. Because the historical paragraph comprises a historical object entity “Group B Streptococcus” which is the same as the recommended subject entity, and the historical object entity has a historical relation “containing” with the historical subject entity “pregnant women” which indeed exists in the current paragraph, the processor 13 therefore determines that the historical paragraph is highly similar to the current paragraph.

In the action 215b, after determining that the historical paragraph is highly similar to the current paragraph, the processor 13 may generate a recommended object entity and a recommended relation corresponding to the recommended subject entity according to the historical subject entity, the historical object entity, and the historical relation corresponding to the historical paragraph which is selected. In other words, the processor 13 may find out the potential triple in the current paragraph where the recommended subject entity is located according to the historical paragraph and the historical triple corresponding thereto. For example, the processor 13 may generate the recommended subject entity “pregnant women”, the recommended relation “containing” and the recommended object entity “Group B Streptococcus” of the current paragraph according to the current paragraph, the historical subject entity, the historical object entity, and the historical relation corresponding to the historical paragraph.

Next, please refer to FIG. 2C and FIG. 2D, in the embodiment shown in FIG. 2C, the processor 13 may complete the operation 21 by performing actions 211c, 213c and 215c , and these actions will be described in detail as follows.

In the action 211c, the processor 13 may analyze the current paragraph to extract a vocabulary from the current paragraph as the recommended subject entity. Details of the action 211c may be the same as those of the action 211b, and thus will not be further described herein.

In the action 213c, the processor 13 may compare the current knowledge graph with each of the plurality of historical knowledge graphs, so as to find out at least one historical-knowledge-graph triple with a similar structure with the plurality of triples of the current knowledge graph from the plurality of historical knowledge graphs. The plurality of historical knowledge graphs may be stored in the database 111. The current knowledge graph may comprise a plurality of confirmed triples corresponding to the text data D1.

After comparing the current knowledge graph with each of the plurality of historical knowledge graphs, if the processor 13 determines that the current knowledge graph and a certain historical knowledge graph have structural similarity (for example, the manner of distribution of the historical triple in the historical paragraph is similar to the manner of distribution of the triple of the current knowledge graph in the current paragraph) and/or have entities corresponding to the same ontology class, then the processor 13 may determine that the current knowledge graph and the historical knowledge graph have similar structures. In other words, if the current paragraph comprises a triple that is the “same” as a historical-knowledge-graph triple in the historical knowledge graph (i.e., the triple in the current paragraph the historical-knowledge-graph triple comprise two entities with exactly the same vocabulary) or “similar” to a historical-knowledge-graph triple in the historical knowledge graph (i.e., the triple in the current paragraph and the historical-knowledge-graph triple comprise two entities of which the vocabularies are different but belong to the same ontology class), then the processor 13 may therefore determine that the current knowledge graph and the historical knowledge graph have a similar structure.

Please refer to FIG. 2D at the same time, and FIG. 2D illustrates a schematic view of a current knowledge graph and a historical knowledge graph according to some embodiments of the present invention. In the embodiment illustrated in FIG. 2D, the text data D1 may correspond to a current knowledge graph K1, and the current knowledge graph K1 comprises two confirmed triples: “newborn-suffering from-meningitis” and “newborn-infected by—Group B Streptococcus”. The database 111 stores a plurality of historical knowledge graphs K2 (for example, a historical knowledge graph K21 and a historical knowledge graph K2 in FIG. 2D), and each of the plurality of historical knowledge graphs K2 may be composed of a plurality of confirmed historical-knowledge-graph triples. Each of the plurality of historical-knowledge-graph triples may individually come from different text data (excluding the text data D1) or knowledge graphs that have been constructed by others, and each of the plurality of historical-knowledge-graph triples may be confirmed and stored in the database 111 before the text data Dl is input.

For example, two historical-knowledge-graph triples comprised in the historical knowledge graph K21 are “newborn-suffering from-meningitis” and “newborn-infected by-Group B Streptococcus”. Because the historical-knowledge-graph triples are the same as the triples “newborn-suffering from-meningitis” and “newborn-infected by—Group B Streptococcus” comprised in the current knowledge graph K1, the processor 13 may determine that the current knowledge graph K1 and the historical knowledge graph K21 have the similar structure.

Then, in the action 215c, after finding out at least one historical-knowledge-graph triple which has the similar structure with the plurality of triples of the current knowledge graph from the plurality of historical knowledge graphs, the processor 13 may generate the at least one recommended object entity and the at least one recommended relation corresponding to the recommended subject entity.

In detail, the processor 13 may take a corresponding entity in the historical-knowledge-graph triple as the recommended object entity according to the recommended subject entity, and take a corresponding relation in the historical-knowledge-graph triple as the recommended relation. For example, if the recommended subject entity is “Group B Streptococcus”, then the processor 13 will search in the text data Dl to find out whether there is a triple that is the same as the historical-knowledge-graph triples “Group B Streptococcus-common in-gastrointestinal tract” and “Group B Streptococcus-causing-pneumonia” in the historical knowledge graph K21, or similar to the two historical-knowledge-graph triples (i.e., a triple with the categories of “virus-common in-organs” and “virus-causing-diseases”).

If the current paragraph in the text data D1 is: “Group B Streptococcus is a common bacterium in human gastrointestinal tract”, then because the paragraph comprises two entities “Group B Streptococcus” and “gastrointestinal tract”, the processor 13 may take the “gastrointestinal tract” as the recommended object entity and take the “common in” as the recommended relation thereof according to the historical-knowledge-graph triple. If the current paragraph of the text data D1 is: “Group B Streptococcus is a common bacterium in human urinary tract”, then because the ontology class “organ” of the “urinary tract” comprised in this paragraph is the same as the ontology class of the “gastrointestinal tract”, the processor 13 may determine that the “urinary tract” is similar to the “gastrointestinal tract”, and may take the “urinary tract” as the recommended object entity, take the “common in” as the recommended relation thereof, and generate a recommended triple “Group B Streptococcus-common in-urinary tract” for the text data D1.

Please further refer to FIG. 2E, in the embodiment shown in FIG. 2E, the processor 13 may complete the operation 21 by performing actions 211e, 213e and 215e, and these actions will be described in detail as follows.

In the action 211e, the processor 13 may input the text data into a recommendation model. In the action 213e, the recommendation model analyzes the current paragraph of the text data to extract the vocabulary as the recommended subject entity. In the action 215e, the recommendation model generates the at least one recommended object entity and the at least one recommended relation corresponding to the recommended subject entity.

In certain embodiments, the recommendation model described in the actions 211e, 213e, and 215e may be established by the processor 13 using a Bi-directional Long Short-Term Memory (Bi-LSTM) algorithm and using at least ten triples among the plurality of triples T1, T2, . . . , Tn stored in the database 111 as training data. The processor 13 may train a deep learning model according to a meta structure composed of the at least ten triples, so that the trained deep learning model is capable of recognizing entities and relations in a text.

In some other embodiments, the recommendation model may also be input into the knowledge graph construction system 1 after being trained in advance by an external device in the same or different ways.

In some embodiments, the plurality of triples T1, T2, , Tn comprise at least ten confirmed triples, and the processor 13 may further be configured to use the at least ten confirmed triples as the training data to retrain and update the recommendation model.

Returning to FIG. 2A, in the operation 23, the operation interface 12 may display the recommended subject entity, the at least one recommended object entity and the at least one recommended relation on a current paragraph in the text data D1 for a user to select.

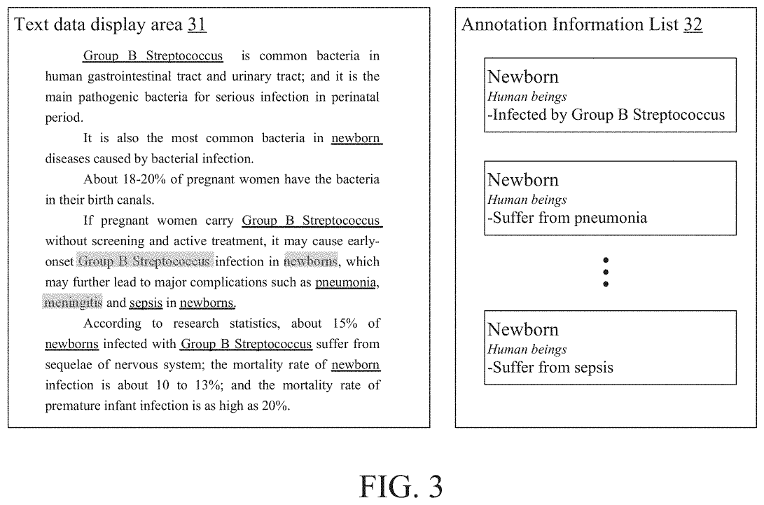

FIG. 3 illustrates a schematic view of displaying the recommended subject entity, the at least one recommended object entity, and the at least one recommended relation on a current paragraph of the text data by the operation interface 12 according to some embodiments of the present invention.

In the embodiment illustrated in FIG. 3, the operation interface 12 may display a text data display area 31 and an annotation information list 32. The text data display area 31 may display all or part of the text data D1, and the text data D1 comprises the current paragraph where the recommended subject entity is located. The operation interface 12 may also display an entity annotation of the recommended subject entity in the text data display area 31. For example, the processor 13 may underline the “newborn” in the text data display area 31 to display the “newborn” as the recommended subject entity. The operation interface 12 may also display the recommended subject entity, the at least one recommended object entity and the at least one recommended relation corresponding to the recommended subject entity on the annotation information list 32 for the user to select.

For example, the annotation information list 32 may display thereon the recommended subject entity “newborn”, the recommended second entities “Group B Streptococcus”, “pneumonia” and “sepsis” corresponding thereto, and these recommended second entities individually correspond to the recommended relations “infected”, “suffering from” and “suffering from”.

In some embodiments, the recommended subject entity and each of the recommended second entities may also individually correspond to an ontology class. For example, the recommended subject entity “newborn” in the annotation information list 32 may correspond to the ontology class “human”. In some embodiments, the processor 13 may similarly display an entity annotation of the recommended object entity in the text data display area 31.

It shall be noted that, the content displayed on the operation interface 12 shown in FIG. 3 is only an example and is not for limitation, and types of the entity annotations and the arrangement of the annotation information list may be set differently according to needs or preferences.

Returning back to FIG. 2A, in the operation 25, the processor 13 may receive a confirmed message M1 through the operation interface 12, and the confirmed message M1 is related to the recommended subject entity, a recommended object entity selected by the user from the at least one recommended object entity, and a recommended relation selected by the user from the at least one recommended relation.

The user may select a recommended object entity and a recommended relation from the at least one recommended object entity and the at least one recommended relation in the annotation information list displayed on the operation interface 12. Then, the operation interface 12 may receive the confirmed message M1 provided by the user, and the confirmed message M1 may correspond to the recommended subject entity, the recommended object entity and the recommended relation selected by the user. In some embodiments, the operation interface 12 may be configured to provide an option to receive the confirmed message M1.

For example, after the user clicks on a recommended object entity and a recommended relation, the operation interface 12 then displays an option for the user to click so as to receive the confirmed message M1.

Next, in the operation 27, the processor 13 may store the recommended subject entity, the recommended object entity which is selected, and the recommended relation which is selected in the database so as to add the recommended subject entity, the recommended object entity which is selected, and the recommended relation which is selected to the plurality of triples. In the operation 29, the processor 13 uses the plurality of triples to construct a current knowledge graph.

In some embodiments, the processor 13 may take the recommended subject entity, the recommended object entity which is selected, and the recommended relation which is selected confirmed by the user as a confirmed triple, and store the confirmed triple in the database 111 so as to add the confirmed triple to the plurality of triples to update the plurality of triples in the database 111. In this way, the updated database 111 will comprise the confirmed triple, and the processor 13 may re-construct a current knowledge graph according to all triples in the updated database 111.

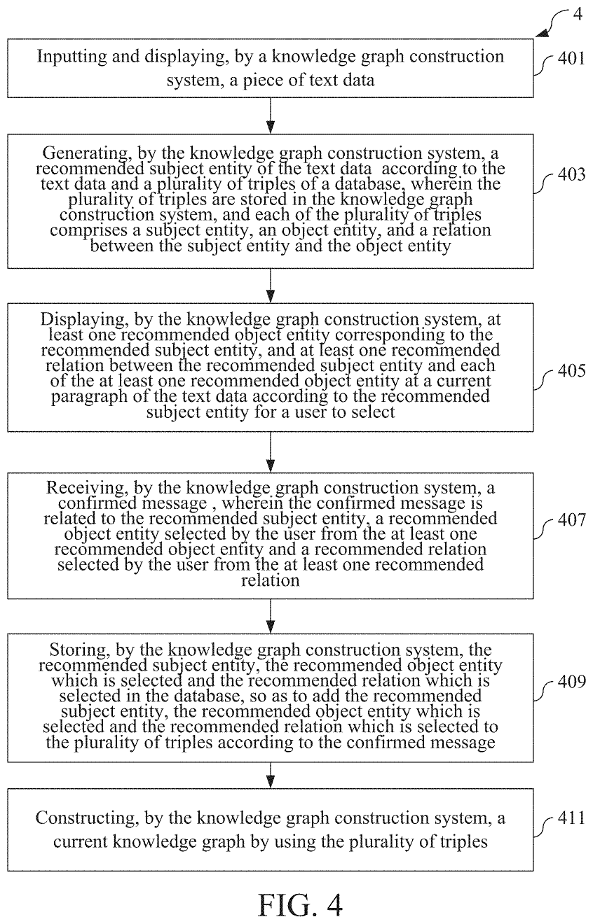

FIG. 4 illustrates a knowledge graph construction method according to some embodiments of the present invention. The content shown in FIG. 4 is for illustrating the embodiment of the present invention instead of limiting the scope of the present invention.

Referring to FIG. 4, a knowledge graph construction method 4 may comprise the following steps: inputting and displaying, by a knowledge graph construction system, a piece of text data (labeled as step 401); generating, by a knowledge graph construction system, a recommended subject entity of the text data according to the text data and a plurality of triples in a database, wherein the plurality of triples are stored in the knowledge graph construction system, and each of the plurality of triples comprises a subject entity, an object entity, and a relation between the subject entity and the object entity (labeled as step 403); displaying, by the knowledge graph construction system, at least one recommended object entity corresponding to the recommended subject entity, and at least one recommended relation between the recommended subject entity and each of the at least one recommended object entity at a current paragraph of the text data according to the recommended subject entity for a user to select (labeled as step 405); receiving, by a knowledge graph construction system, a confirmed message, wherein the confirmed message is related to the recommended subject entity, a recommended object entity selected by the user from the at least one recommended object entity, and a recommended relation selected by the user from the at least one recommended relation (labeled as step 407); storing, by the knowledge graph construction system, the recommended subject entity, the recommended object entity which is selected, and the recommended relation which is selected in the database according to the confirmed message, so as to add the recommended subject entity, the recommended object entity which is selected, and the recommended relation which is selected to the plurality of triples (labeled as step 409); and constructing, by the knowledge graph construction system, a current knowledge graph by using the plurality of triples (labeled as step 411).

In some embodiments, in addition to the steps 401 to 411, the knowledge graph construction method 4 may further comprise the following step: analyzing, by the knowledge graph construction system, the current paragraph to extract a vocabulary from the current paragraph as the recommended subject entity.

In some embodiments, the knowledge graph construction system may store a plurality of historical paragraphs and may store a historical subject entity, a historical object entity, and a historical relation which individually corresponding to each of the plurality of historical paragraphs, and the knowledge graph construction method 4 may further comprise the following steps: analyzing, by the knowledge graph construction system, the current paragraph to extract a vocabulary from the current paragraph as the recommended subject entity; comparing, by the knowledge graph construction system, the current paragraph with each of the plurality of historical paragraphs and selecting a historical paragraph which is highly similar to the current paragraph from the plurality of historical paragraphs; and generating, by the knowledge graph construction system, a recommended object entity and a recommended relation corresponding to the recommended subject entity according to the historical subject entity, the historical object entity, and the historical relation corresponding to the historical paragraph which is selected.

In some embodiments, in addition to the steps 401 to 411, the knowledge graph construction method 4 may further comprise the following steps: displaying, by the knowledge graph construction system, an entity annotation on the recommended subject entity in the text data; and displaying, by the knowledge graph construction system, an annotation information list, wherein the annotation information list comprises the at least one recommended object entity and the at least one recommended relation corresponding to the recommended subject entity for the user to select.

In some embodiments, in addition to the steps 401 to 411, the knowledge graph construction method 4 may further comprise the following steps: displaying, by the knowledge graph construction system, an entity annotation on the recommended subject entity in the text data; and displaying, by the knowledge graph construction system, an annotation information list, wherein the annotation information list comprises the at least one recommended object entity and the at least one recommended relation corresponding to the recommended subject entity for the user to select. The recommended subject entity and each of the at least one recommended object entity individually correspond to an ontology class, and an entity annotation of each of the at least one recommended object entity is also displayed in the knowledge graph construction system and the annotation information list.

In some embodiments, in addition to the steps 401 to 411, the knowledge graph construction method 4 may further comprise the following steps: displaying, by the knowledge graph construction system, an entity annotation on the recommended subject entity in the text data; displaying, by the knowledge graph construction system, an annotation information list, wherein the annotation information list comprises the at least one recommended object entity and the at least one recommended relation corresponding to the recommended subject entity for the user to select; and providing, by the knowledge graph construction system, an option to receive the confirmed message. The recommended subject entity and each of the at least one recommended object entity individually correspond to an ontology class, and an entity annotation of each of the at least one recommended object entity is also displayed in the knowledge graph construction system and the annotation information list.

In some embodiments, the knowledge graph construction system may store a plurality of historical knowledge graphs, and in addition to the steps 401 to 411, the knowledge graph construction method 4 may further comprise the following steps: analyzing, by the knowledge graph construction system, the current paragraph to extract a vocabulary from the current paragraph as the recommended subject entity; and comparing, by the knowledge graph construction system, the current knowledge graph with each of the plurality of historical knowledge graphs, finding out at least one historical-knowledge-graph triple which has a similar structure with the plurality of triples of the current knowledge graph from the plurality of historical knowledge graphs, so as to generate the at least one recommended object entity and the at least one recommended relation corresponding to the recommended subject entity.

In some embodiments, for the knowledge graph construction method 4, the plurality of triples at least comprise at least one confirmed triple in the text data.

In some embodiments, in addition to the steps 401 to 411, the knowledge graph construction method 4 may further comprise the following steps: analyzing, by the knowledge graph construction system, the current paragraph to extract a vocabulary from the current paragraph as the recommended subject entity; and generating, by the knowledge graph construction system, the at least one recommended object entity and the at least one recommended relation corresponding to the recommended subject entity. The knowledge graph construction system establishes a recommendation model by using a Bi-Directional Long Short-Term Memory (Bi-LSTM) algorithm and using at least ten triples in the plurality of triples as training data; and the knowledge graph construction system analyzes the current paragraph of the text data by inputting the text data into the recommendation model to extract the vocabulary as the recommended subject entity, and generates the at least one recommended object entity and the at least one recommended relation corresponding to the recommended subject entity.

In some embodiments, the plurality of triples stored in the knowledge graph construction system at least comprise at least ten confirmed triples, and in addition to the steps 401 to 411, the knowledge graph construction method 4 may further comprise the following steps: analyzing, by the knowledge graph construction system, the current paragraph to extract a vocabulary from the current paragraph as the recommended subject entity; and generating, by the knowledge graph construction system, the at least one recommended object entity and the at least one recommended relation corresponding to the recommended subject entity; and retraining and updating, by the knowledge graph construction system, the recommendation model by using the at least ten triples as the training data. The knowledge graph construction system establishes a recommendation model by using a Bi-Directional Long Short-Term Memory (Bi-LSTM) algorithm and using at least ten triples in the plurality of triples as training data; and the knowledge graph construction system analyzes the current paragraph of the text data by inputting the text data into the recommendation model to extract the vocabulary as the recommended subject entity, and generates the at least one recommended object entity and the at least one recommended relation corresponding to the recommended subject entity.

The knowledge graph construction system executing the knowledge graph construction method 4 may be the knowledge graph construction system 1 described in FIG. 1. That is, each embodiment of the knowledge graph construction method 4 essentially corresponds to a certain embodiment of the knowledge graph construction system 1. Therefore, even though each embodiment of the knowledge graph construction method 4 is not described in detail above, a person having ordinary skill in the art can directly appreciate the embodiments of the knowledge graph construction method 4 that are not described in detail according to the above description of the knowledge graph construction system 1.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A knowledge graph construction system, comprising:
an operation interface, being configured to input and display a piece of text data;
a storage, comprising a database which is configured to store a plurality of triples, wherein each of the plurality of triples comprises a subject entity, an object entity, and a relation between the subject entity and the object entity; and
a processor, being electrically connected to the operation interface and the storage, and being configured to:
generate a recommended subject entity of the text data according to the text data and the plurality of triples in the database;
display, through the operation interface, at least one recommended object entity corresponding to the recommended subject entity, and at least one recommended relation between the recommended subject entity and each of the at least one recommended object entity at a current paragraph of the text data according to the recommended subject entity for a user to select;
receive, through the operation interface, a confirmed message, wherein the confirmed message is related to the recommended subject entity, a recommended object entity selected by the user from the at least one recommended object entity, and a recommended relation selected by the user from the at least one recommended relation;
store the recommended subject entity, the recommended object entity which is selected, and the recommended relation which is selected in the database according to the confirmed message, so as to add the recommended subject entity, the recommended object entity which is selected, and the recommended relation which is selected to the plurality of triples; and
construct a current knowledge graph by using the plurality of triples.

2. The knowledge graph construction system of claim 1, wherein the processor is further configured to analyze the current paragraph to extract a vocabulary from the current paragraph as the recommended subject entity.

3. The knowledge graph construction system of claim 2, wherein:
the database is further configured to store a plurality of historical paragraphs and store a historical subject entity, a historical object entity, and a historical relation which individually corresponding to each of the plurality of historical paragraphs; and
the processor is further configured to compare the current paragraph with each of the plurality of historical paragraphs, select a historical paragraph which is highly similar to the current paragraph from the plurality of historical paragraphs, and generate a recommended object entity and a recommended relation corresponding to the recommended subject entity according to the historical subject entity, the historical object entity, and the historical relation corresponding to the historical paragraph which is selected.

4. The knowledge graph construction system of claim 1, wherein the operation interface is further configured to:
display an entity annotation on the recommended subject entity in the text data; and
display an annotation information list, wherein the annotation information list comprises the at least one recommended object entity and the at least one recommended relation corresponding to the recommended subject entity for the user to select.

5. The knowledge graph construction system of claim 4, wherein the recommended subject entity and each of the at least one recommended object entity individually correspond to an ontology class, and an entity annotation of each of the at least one recommended object entity is also displayed on the operation interface and the annotation information list.

6. The knowledge graph construction system of claim 4, wherein the operation interface is further configured to provide an option to receive the confirmed message.

7. The knowledge graph construction system of claim 2, wherein:
the database is further configured to store a plurality of historical knowledge graphs; and
the processor is further configured to compare the current knowledge graph with each of the plurality of historical knowledge graphs, find out at least one historical-knowledge-graph triple which has a similar structure with the plurality of triples of the current knowledge graph from the plurality of historical knowledge graphs, so as to generate the at least one recommended object entity and the at least one recommended relation corresponding to the recommended subject entity.

8. The knowledge graph construction system of claim 1, wherein the plurality of triples at least comprise at least one confirmed triple in the text data.

9. The knowledge graph construction system of claim 2, wherein:
the processor is further configured to establish a recommendation model by using a Bi-Directional Long Short-Term Memory (Bi-LSTM) algorithm and using at least ten triples of the plurality of triples as training data; and
the processor analyzes the current paragraph of the text data by inputting the text data into the recommendation model to extract the vocabulary as the recommended subject entity, and generates the at least one recommended object entity and the at least one recommended relation corresponding to the recommended subject entity.

10. The knowledge graph construction system of claim 9, wherein:
the plurality of triples stored in the database at least comprise at least ten confirmed triples; and
the processor is further configured to retrain and update the recommendation model by using the at least ten confirmed triples as the training data.

11. A knowledge graph construction method, comprising:
inputting and displaying, by a knowledge graph construction system, a piece of text data;
generating, by the knowledge graph construction system, a recommended subject entity of the text data according to the text data and a plurality of triples in a database, wherein the plurality of triples are stored in the knowledge graph construction system, and each of the plurality of triples comprises a subject entity, an object entity, and a relation between the subject entity and the object entity;
displaying, by the knowledge graph construction system, at least one recommended object entity corresponding to the recommended subject entity, and at least one recommended relation between the recommended subject entity and each of the at least one recommended object entity at a current paragraph of the text data according to the recommended subject entity for a user to select;
receiving, by the knowledge graph construction system, a confirmed message, wherein the confirmed message is related to the recommended subject entity, a recommended object entity selected by the user from the at least one recommended object entity, and a recommended relation selected by the user from the at least one recommended relation;
storing, by the knowledge graph construction system, the recommended subject entity, the recommended object entity which is selected, and the recommended relation which is selected in the database according to the confirmed message, so as to add the recommended subject entity, the recommended object entity which is selected, and the recommended relation which is selected to the plurality of triples; and
constructing, by the knowledge graph construction system, a current knowledge graph by using the plurality of triples.

12. The knowledge graph construction method of claim 11, further comprising:
analyzing, by the knowledge graph construction system, the current paragraph to extract a vocabulary from the current paragraph as the recommended subject entity.

13. The knowledge graph construction method of claim 12, wherein:
the knowledge graph construction system stores a plurality of historical paragraphs and stores a historical subject entity, a historical object entity, and a historical relation which individually corresponding to each of the plurality of historical paragraphs; and
the knowledge graph construction method further comprises:
comparing, by the knowledge graph construction system, the current paragraph with each of the plurality of historical paragraphs, and selecting a historical paragraph which is highly similar to the current paragraph from the plurality of historical paragraphs; and
generating, by the knowledge graph construction system, a recommended object entity and a recommended relation corresponding to the recommended subject entity according to the historical subject entity, the historical object entity, and the historical relation corresponding to the historical paragraph which is selected.

14. The knowledge graph construction method of claim 11, further comprising:
displaying, by the knowledge graph construction system, an entity annotation on the recommended subject entity in the text data; and
displaying, by the knowledge graph construction system, an annotation information list, wherein the annotation information list comprises the at least one recommended object entity and the at least one recommended relation corresponding to the recommended subject entity for the user to select.

15. The knowledge graph construction method of claim 14, wherein the recommended subject entity and each of the at least one recommended object entity individually correspond to an ontology class, and an entity annotation of each of the at least one recommended object entity is also displayed in the knowledge graph construction system and the annotation information list.

16. The knowledge graph construction method of claim 14, further comprising:
providing, by the knowledge graph construction system, an option to receive the confirmed message.

17. The knowledge graph construction method of claim 12, wherein:
the knowledge graph construction system stores a plurality of historical knowledge graphs; and
the knowledge graph construction method further comprises:
comparing, by the knowledge graph construction system, the current knowledge graph with each of the plurality of historical knowledge graphs, finding out at least one historical-knowledge-graph triple which has a similar structure with the plurality of triples of the current knowledge graph from the plurality of historical knowledge graphs, so as to generate the at least one recommended object entity and the at least one recommended relation corresponding to the recommended subject entity.

18. The knowledge graph construction method of claim 11, wherein the plurality of triples at least comprise at least one confirmed triple in the text data.

19. The knowledge graph construction method of claim 12, further comprising:
establishing, by the knowledge graph construction system, a recommendation model by using a Bi-Directional Long Short-Term Memory (Bi-LSTM) algorithm and using at least ten triples of the plurality of triples as training data; and
analyzing, by the knowledge graph construction system, the current paragraph of the text data by inputting the text data into the recommendation model to extract the vocabulary as the recommended subject entity, and generating the at least one recommended object entity and the at least one recommended relation corresponding to the recommended subject entity.

20. The knowledge graph construction method of claim 19, wherein:
the plurality of triples stored in the knowledge graph construction system at least comprise at least ten confirmed triples; and
the knowledge graph construction method further comprises:
retraining and updating, by the knowledge graph construction system, the recommendation model by using the at least ten confirmed triples as the training data.
